(19) United States
(12) Patent Application Publication
(10) Pub. No.: US 2012/0157015 A1
(43) Pub. Date: Jun. 21, 2012

(54) SEMICONDUCTOR DEVICE AND SEMICONDUCTOR CONTROL SYSTEM INCLUDING THE SAME

(76) Inventors: Jun-Gi CHOI, Gyeonggi-do (KR); Jeong-Ho CHO, Gyeonggi-do (KR); Hyung-Jun CHO, Gyeonggi-do (KR)

(21) Appl. No.: 13/048,283

(22) Filed: Mar. 15, 2011

(30) Foreign Application Priority Data
Dec. 21, 2010 (KR) 10-2010-0131532

(51) Int. Cl. H04B 1/38; H01Q 1/38

(52) U.S. Cl. 455/90.2; 343/895

(57) ABSTRACT

A semiconductor device includes an interface pad, and an antenna formed to surround the interface pad. The semiconductor device may further include a buffer configured to receive a first input signal applied to the interface pad, a driver configured to output a first output signal to the interface pad a receiver configured to receive a second input signal transferred to the antenna, and a transmitter configured to output a second output signal to the antenna.

### CROSS-REFERENCE TO RELATED APPLICATIONS

The present application claims priority of Korean Patent Application No. 10-2010-0131532, filed on Dec. 21, 2010, which is incorporated herein by reference in its entirety.

### BACKGROUND OF THE INVENTION

Exemplary embodiments of the present invention relate to a semiconductor device.

Semiconductor devices may be produced as a chip and tested to see whether they operate normally before they are shipped out of factory. Testing the semiconductor devices is helpful in selectively removing defective products.

Semiconductor devices are generally coupled with a control device, e.g., a memory controller or a testing device, through cables. The test of a semiconductor device may be performed when the semiconductor device is formed on a wafer. A semiconductor device on a wafer is coupled with a testing device through cables and tested in the following method. The testing device generating an electrical signal is electrically connected with a probe card, and a plurality of probe needles included in the probe card are coupled with an input/output pad of the semiconductor device through cables, and then the electrical signal generated in the testing device is applied to the semiconductor device.

However, when the interface pad of the semiconductor device is coupled with the multiple probe needles through cables, there are limitations in reducing the size of an end of the probe needle. In addition, as the size of the end of the probe needle decreases, self-inductance and resistance increase and proper exchange of signals between the semiconductor device and the probe card may be difficult to obtain. Further, the probe card may be applied with pressure to be coupled with the semiconductor device and thus, the probe needles may unwontedly place marks on the semiconductor device. As the size of the end of each probe needle decreases, the pressure applied to the probe needle may increase and the resulting mark placed on the interface pad may grow large and hinder the coupling between the probe needle and the interface pad.

### SUMMARY OF THE INVENTION

An embodiment of the present invention is directed to a semiconductor device which exchanges electrical signals with a control device wirelessly by using an antenna while having a relatively small area.

In accordance with an aspect of the present invention, a semiconductor device includes: an interface pad; and an antenna formed to surround the interface pad.

In accordance with another aspect of the present invention, a semiconductor control system includes: a semiconductor device comprising an interface pad and a first antenna surrounding the interface pad; and a semiconductor control device comprising a second antenna and configured to communicate with the semiconductor device through the first and second antennas during a first operation mode.

### BRIEF DESCRIPTION OF THE DRAWINGS

FIG. 1 is a block diagram illustrating a semiconductor control system in accordance with an embodiment of the present invention.

FIG. 2 is a diagram illustrating a plan view of a first antenna 112 of a semiconductor device 110 formed in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

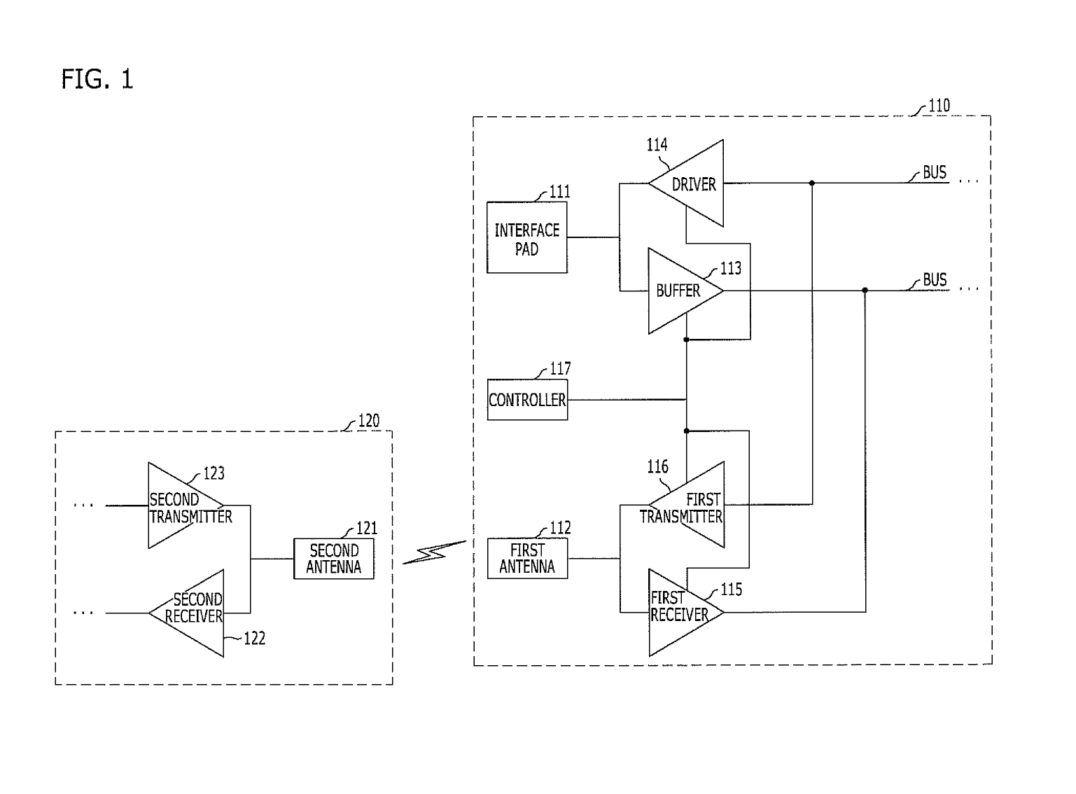

FIG. 1 is a block diagram illustrating a semiconductor control system in accordance with an embodiment of the present invention.

Unlike signal transfer using a conventional wired connection, signals are wirelessly transferred between a semiconductor device 110 and a semiconductor control device 120. Such a wireless communication may use a close range wireless communication, where a first antenna 112 of the semiconductor device 110 and a second antenna 121 of the semiconductor control device 120 are positioned close to each other to exchange electrical signals.

Referring to FIG. 1, the semiconductor control system includes the semiconductor device 110 and the semiconductor control device 120.

The semiconductor device 110 includes an interface pad 111, the first antenna 112, a buffer 113 for receiving an input signal applied to the interface pad 111, a driver 114 for outputting an output signal to the interface pad 111, a first receiver 115 for receiving an input signal transferred to the first antenna 112, a first transmitter 116 for outputting an output signal to the first antenna 112, a controller 117 for controlling the first receiver 115 and the first transmitter 116 to be linked with an internal bus BUS during an operation in a wireless operation mode and controlling the buffer 113 and the driver 114 to be linked with the internal bus BUS during an operation in a wired operation mode.

The semiconductor control device 120 includes the second antenna 121 for communicating with the first antenna 112 during the operation in the wireless operation mode, a second receiver 122 for receiving an input signal transferred to the second antenna 121, and a second transmitter 123 for outputting an output signal to the second antenna 121.

In the semiconductor control system in accordance with the embodiment of the present invention, the semiconductor device 110 wirelessly communicates with an external device during the operation in the wireless operation mode, and communicates with the external device through cables in the operation of the wired operation mode. Since the wired operation is more stable than the wireless operation, the semiconductor device 110 may be operated in the wired operation mode when the semiconductor device 110 actually performs its operations. However, when the semiconductor device 110 is being tested, it may be tested using the wireless operation mode. Hereafter, a case where the semiconductor device 110 operates in the wireless operation mode to be tested and the semiconductor device 110 operates in the wired operation mode to perform a normal operation is described.

Referring to FIG. 1, the operation of the semiconductor control system is described.

The way that the semiconductor device 110 of the embodiment of the present invention operates becomes different according to whether the operation is for a test (which is the wireless operation mode) or an actual/normal operation (which is the wired operation mode). First, the way that the semiconductor device 110 communicates with an external device, e.g., the testing device 120, during a test is described, and then the way that the semiconductor device 110 communicates with an external device, e.g., a control device (not shown in FIG. 1), during an actual operation is described.

(1) Communication between Semiconductor Device 110 and External Device, e.g., Testing Device 120, during Test (Operation in Wireless Operation Mode)

An internal circuit (not shown in FIG. 1) of the testing device 120 generates an electrical signal. The electrical signal is a signal for operating the semiconductor device 110 in a testing environment. The electrical signal generated in the internal circuit of the testing device 120 is transferred to the first antenna 112 through the second antenna 121 by the second transmitter 123.

During the test (that is, during the operation in the wireless operation mode), the semiconductor device 110 wirelessly communicates with the testing device 120 through the first antenna 112. Therefore, the controller 117 links the first receiver 115 and the first transmitter 116 with the internal bus BUS to input/output the electrical signal to/from the internal circuit of the semiconductor device 110 through the first antenna 112. The electrical signal inputted to the first receiver 115 passes through the internal bus BUS and is transferred to the internal circuit (not shown in FIG. 1) of the semiconductor device 110, and the internal circuit of the semiconductor device 110 performs a desired operation in response to the electrical signal.

An operation result of the internal circuit of the semiconductor device 110 is transferred to the first transmitter 116 through the internal bus BUS. The first transmitter 116 outputs the result to the first antenna 112 as its output signal. Here, the first antenna 112 outputs the result as an input signal of the second antenna 121.

When the operation result of the semiconductor device 110 is transferred to the second antenna 121 through the first antenna 112, it is inputted through the second receiver 122 and transferred to the internal circuit of the testing device 120. The internal circuit of the testing device 120 decides whether the semiconductor device 110 is defective or not based on the operation result of the semiconductor device 110.

Here, when a semiconductor device 110 is tested with a plurality of electrical signals, the semiconductor device 110 may have a plurality of first antennas 112, a plurality of first receivers 115, and a plurality of first transmitters 116. A testing device 120 may also have a plurality of second antennas 121, a plurality of second receivers 122, and a plurality of second transmitters 123 to wirelessly communicate with the plurality of the first antennas 112.

(2) Communication between Semiconductor Device 110 and External Device, e.g., Control Device, during Actual Operation (Normal Operation or Operation in Wired Operation Mode)

During the actual operation (that is, during the operation in the wired operation mode), the semiconductor device 110 communicates with the external device through cables via the interface pad 111. Therefore, the controller 117 links the buffer 113 and the driver 114 with the internal bus BUS to input/output an electrical signal to/from the internal circuit of the semiconductor device 110 through the interface pad 111. The electrical signal inputted to the buffer 113 passes through the internal bus BUS and is transferred to the internal circuit of the semiconductor device 110, and the internal circuit of the semiconductor device 110 performs a desired operation in response to the electrical signal. Here, the actual operation means the operation of the semiconductor device 110 performed by being actually used after passing a test.

An operation result (which is an operation result signal) of the internal circuit of the semiconductor device 110 is transferred to the driver 114 through the internal bus BUS. The driver 114 outputs the operation result signal to the interface pad 111 as its output signal.

For example, the semiconductor device 110 includes both the wired communication module 111, 113, and 114 for wired communication and the wireless communication module 112, 115, and 116 for wireless communication, communicates with an external device through the wireless communication module 112, 115, and 116 during a test, and communicates with an external device through the wired communication module 111, 113, and 114 during an actual operation. In short, the semiconductor device 110 uses a favorable communication method between the wireless communication and the wired communication, and the selection of the communication module is made by the controller 117.

Here, the actual operation of the semiconductor device 110 signifies the original and core operation of the semiconductor device itself, such as a computation operation in case of a Central Processing Unit (CPU), an operation of storing and inputting/outputting data in case of a memory device, and an operation of converting a digital signal into an analog signal in case of a digital-to-analog converter.

Hereafter, a case where the semiconductor control system of the embodiment of the present invention is applied to a memory test system is described. In this case, the semiconductor device 110 includes a plurality of first antennas 112, a plurality of first receivers 115, and a plurality of first transmitters 116, and the testing device 120 includes a plurality of second antennas 121, a plurality of second receivers 122, and a plurality of second transmitters 123.

An internal circuit of the testing device 120 generates a write command, an address, and a data. The generated write command, address, and data are outputted to each second antenna 121 through each second transmitter 123. The outputted write command, address, and data are transferred to each first antenna 112 wirelessly, and each first receiver 115 receives the write command, the address, and the data and transfers them to the internal circuit of the semiconductor device 110 through the internal bus BUS. The data is stored in a memory cell designated by the address in the internal circuit of the semiconductor device 110.

Subsequently, the internal circuit of the testing device 120 generates a read command and an address. The generated read command and address are transferred to the internal circuit of the semiconductor device 110 through the same process described in the above, and a data is outputted from the cell designated by the address. The data passes through the internal bus BUS and is outputted from the first transmitters 116 to the first antennas 112. The outputted data are transferred to the second antennas 121 wirelessly, and when the second receivers 122 receive the data and transfer the data to the internal circuit of the testing device 120, the internal circuit of the testing device 120 decides whether the semiconductor device 110 is defective or not.

In this case, the controllers 117 links the first receivers 115 and the first transmitters 116 with the internal bus BUS. When the test is completed and the semiconductor device 110 is actually used, the semiconductor device 110 communicates with the control device through cables via the interface pad 111. Therefore, the controller 117 links the buffer 113 and the driver 114 with the internal bus BUS.

When the exchange of electrical signals for testing the semiconductor device 110 is performed wirelessly, the misconnection between a probe needle and the interface pad 111 which may occur due to the decreasing size of the end of a probe needle may be prevented. However, the area of the semiconductor device may be increased to set up antennas. Therefore, it is desired to develop a method that may minimize the area of a semiconductor device even if antennas are set up.

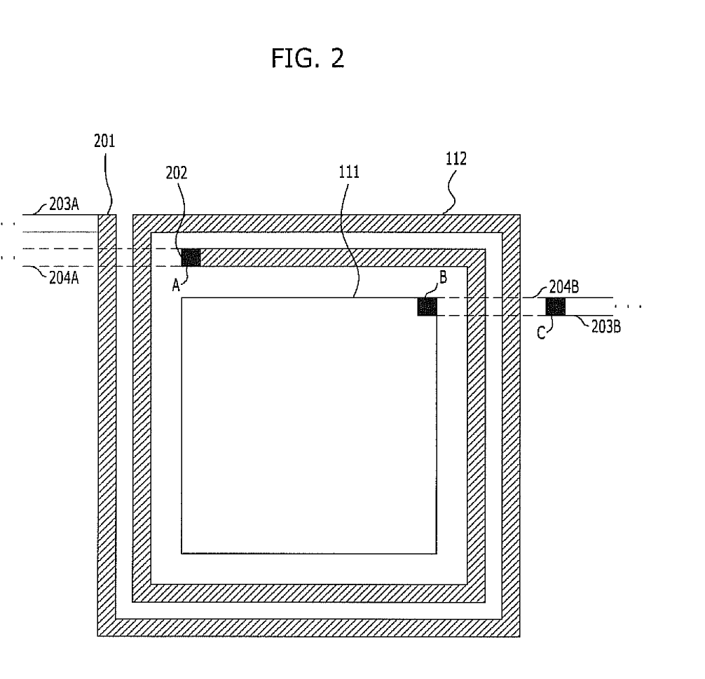

FIG. 2 is a diagram illustrating a plan view of a first antenna 112 of a semiconductor device 110 formed in accordance with an embodiment of the present invention.

Referring to FIG. 2, the first antenna 112 surrounds the interface pad 111 and it is shaped in a spiral. The spiral-shaped first antenna 112 includes the interface pad 111 disposed inside.

A first end 201 and a second end 202 of the first antenna 112 are electrically connected to the first receiver 115 and the first transmitter 116. Through the electrical connection, the first receiver 115 receives an input signal transferred to the first antenna 112, and the first transmitter 116 outputs an output signal to the first antenna 112. The interface pad 111 is coupled with the buffer 113 and the driver 114.

The first end 201 of the first antenna 112 is coupled with the first transmitter 116 and the first receiver 115 through a metal line 203A of a first layer, and the second end 202 of the first antenna 112 are coupled with the first transmitter 116 and the first receiver 115 through a metal line 204A of a second layer. Here, the first layer may be formed on a height which is the same as that of the first antenna 112. In other words, the first end 201 of the first antenna 112 is coupled with the first transmitter 116 and the first receiver 115 through a metal line positioned on the plane of the same height as that of the first antenna 112. The second layer may be formed on a height lower than the height of the first antenna 112. In other words, the second end 202 of the first antenna 112 is coupled with the first transmitter 116 and the first receiver 115 through the metal line 204A positioned on the plane of a different height from that of the first antenna 112. Therefore, a contact A is formed between the second end 202 of the first antenna 112 and the metal line 204A of the second layer.

The interface pad 111 is coupled with the buffer 113 and the driver 114 through a metal line 203B of the first layer. Since the first antenna 112 is formed on the outskirt of the interface pad 111, the metal line 203B of the first layer is not formed to be directly coupled with the interface pad 111. First, a contact B is formed on the bottom of the interface pad 111 to be coupled with a metal line 204B of the second layer. At the outskirt of the first antenna 112, the metal line 204B of the second layer forms a contact C with the metal line 203B of the first layer. Accordingly, the metal line 2046 of the second layer is coupled with the first transmitter 116 and the first receiver 115 through the metal line 203B of the first layer.

When the first antenna 112 for wireless communication is formed apart from the interface pad 111, the area of the semiconductor device 110 may be increased a lot. However, as illustrated in FIG. 2, when the spiral-type first antenna 112 is formed to surround the interface pad 111 while minimizing the area of the interface pad 111, the area of the semiconductor device 110 may be prevented from increasing.

A semiconductor device according to an embodiment of the present invention prevent errors in exchanging electrical signals with a control device through cables by including an antenna and exchanging electrical signals with a control device wirelessly while minimizing the occupied area thereof.

While the present invention has been described with respect to the specific embodiments, it will be apparent to those skilled in the art that various changes and modifications may be made without departing from the spirit and scope of the invention as defined in the following claims.

What is claimed is:

1. A semiconductor device comprising:
an interface pad; and
an antenna formed to surround the interface pad.

2. The semiconductor device of claim 1, wherein the antenna has a spiral shape.

3. The semiconductor device of claim 1, wherein the semiconductor device is configured to communicate with a first external device through the interface pad during a wired operation mode, and the semiconductor device is further configured to communicate with a second external device wirelessly through the antenna during a wireless operation mode.

4. The semiconductor device of claim 3, wherein the interface pad is coupled with the first external device through cables.

5. The semiconductor device of claim 3, further comprising:
a buffer configured to receive a first input signal applied to the interface pad;
a driver configured to output a first output signal to the interface pad;
a receiver configured to receive a second input signal transferred to the antenna; and
a transmitter configured to output a second output signal to the antenna.

6. The semiconductor device of claim 5, further comprising:
a controller configured to control the receiver and the transmitter to be linked with an internal bus during the wireless operation mode and control the buffer and the driver to be linked with the internal bus during the wired operation mode.

7. The semiconductor device of claim 6, wherein the first and second input signals include commands, addresses, or data, and the first and second output signals include data.

8. The semiconductor device of claim 5, wherein a first end of the antenna is coupled with the transmitter and the receiver through a metal line of a first layer and a second end of the antenna is coupled with the transmitter and the receiver through a metal line of a second layer which is different from the first layer.

9. The semiconductor device of claim 8, wherein the interface pad is coupled with the buffer and the driver through the metal line of the second layer.

10. The semiconductor device of claim 3, wherein the wireless operation mode is an operation mode used for testing the semiconductor device and the wired operation mode is an operation mode used for a normal operation of the semiconductor device.

11. A semiconductor control system comprising:
a semiconductor device comprising an interface pad and a first antenna surrounding the interface pad; and
a semiconductor control device comprising a second antenna and configured to communicate with the semiconductor device through the first and second antennas during a first operation mode.

12. The semiconductor control system of claim 11, wherein the first antenna has a spiral shape.

13. The semiconductor control system of claim 11, wherein the semiconductor device further comprises:
a buffer configured to receive a first input signal applied to the interface pad;
a driver configured to output a first output signal to the interface pad;
a first receiver configured to receive a second input signal transferred to the first antenna; and
a first transmitter configured to output a second output signal to the first antenna.

14. The semiconductor control system of claim 13, wherein the semiconductor device further comprises:
a controller configured to control the first receiver and the first transmitter to be linked with an internal bus during the first operation mode and control the buffer and the driver to be linked with the internal bus during a second operation mode.

15. The semiconductor control system of claim 14, wherein the first operation mode includes a wireless operation mode used for testing the semiconductor device, the second operation mode includes a wired operation mode used for a normal operation of the semiconductor device, and the semiconductor control device includes a testing device used for testing the semiconductor device.

16. The semiconductor control system of claim 13, wherein the semiconductor control device further comprises:
a second receiver configured to receive a third input signal transferred to the second antenna; and
a second transmitter configured to output a third output signal to the second antenna.

17. The semiconductor control system of claim 13, wherein a first end of the first antenna is coupled with the first transmitter and the first receiver through a metal line of a first layer, and a second end of the first antenna is coupled with the first transmitter and the first receiver through a metal line of a second layer which is different from the first layer.

18. The semiconductor control system of claim 17, wherein the interface pad is coupled with the buffer and the driver through the metal line of the second layer.

19. The semiconductor device of claim 11, wherein the semiconductor control device is configured to test an operation of the semiconductor device in the first operation mode by wirelessly exchanging commands, addresses, or data with the semiconductor device through the first and second antennas.
